(19) United States
(12) Patent Application Publication
(10) Pub. No.: US 2011/0067639 A1
(43) Pub. Date: Mar. 24, 2011

(54) Pet Litter Box

(76) Inventor: Rhonda Bauer, Granada, MN (US)

(21) Appl. No.: 12/565,040

(22) Filed: Sep. 23, 2009

(51) Int. Cl. A01K 29/00

(52) U.S. Cl. 119/166; 119/165

(57) ABSTRACT

The invention is directed to a pet litter box that has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion.

### RELATED APPLICATIONS

None

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

It is common for cat owners to have a litter box in their house. The simplest litter box is a shallow rectangular box that holds the litter. Some owner use a plastic bag to encase the litter box. The plastic bag keeps the box clean and facilitates throwing out the used litter. However, this system does not keep other pets such as dogs from snacking or prevent the cat from tracking litter out of the box. Enclosed litter boxes have been produced and this help eliminate snacking, but does not prevent litter tracking. There have also been attempts to provide grates in litter boxes to prevent tracking. However, all these previous solutions have not prevented tracking because the cat just jumps over the grate, thereby defeating it purpose.

Thus there exists a need for a litter box that stops dog snacking, reduces tracking, stops urine leaks and can be shipped inexpensively.

### BRIEF SUMMARY OF INVENTION

A pet litter box that overcomes these and other problems has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor.

The upper portion and internal divider of the litter box can be nested inside the lower portion for easy shipping. The upper portion and grate floor bar dogs from snacking. Overlapping edges between the upper and lower portions of the litter box stops urine leaks.

### BRIEF DESCRIPTION OF THE SEVERAL VIEWS OF THE DRAWINGS

FIG. 1 is a top left perspective view of a pet litter box in accordance with one embodiment of the invention;

FIG. 2 is an exploded view of the pet litter box in accordance with one embodiment of the invention; and

FIG. 3 is a top left perspective view of the pet litter box nested for shipping in accordance with one embodiment of the invention.

### DETAILED DESCRIPTION OF THE INVENTION

The invention is directed to a pet litter box that has a lower portion having a bottom wall and four lower portion side walls that are at slightly more than ninety degrees from the bottom wall. An upper portion has a top wall and four upper portion side walls. A cutout portion in one of the four upper portion side walls forms a pet ingress and egress point. The four upper side walls terminate in a groove that mates with a lip formed by the four lower portion side walls. An internal divider has a floor grate that extends along a length of the lower portion and has a wall at approximately ninety degrees to the floor grate. The wall does not extend the length of the lower portion. A divider groove mates with the lip of the lower portion, whereby a pet entering or exiting the pet litter box is required to make a turn on the grate. Forcing a cat to make a turn when exiting the litter box makes sure the cat does not just jump over the grate. This ensures that most of the litter on the cat's paws is removed while jumping onto the grate floor and walking along the grate floor.

The upper portion and internal divider of the litter box can be nested inside the lower portion for easy shipping. The upper portion and grate floor bar dogs from snacking. Overlapping edges between the upper and lower portions of the litter box stops urine leaks.

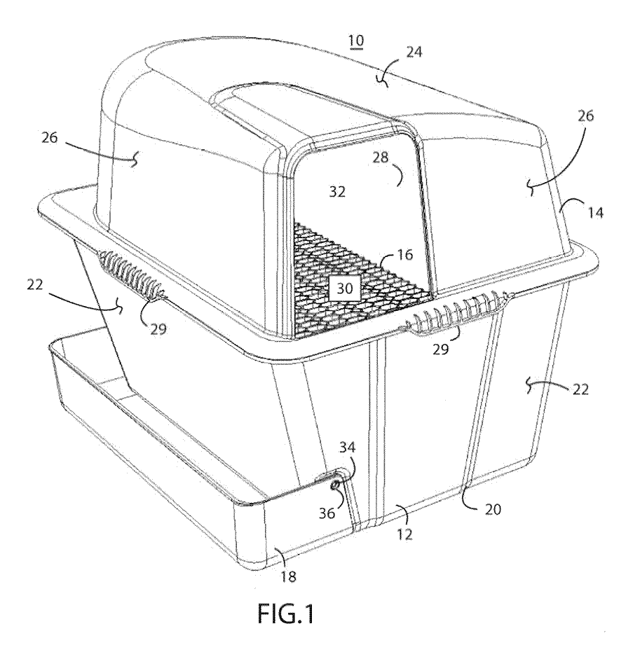

FIG. 1 is a top left perspective view of a pet litter box 10 in accordance with one embodiment of the invention. The litter box 10 has a lower portion 12, an upper portion 14, an internal divider 16, and a storage shelf 18. The lower portion 12 has a bottom wall 20 and four upper portions side walls 22. The side walls 22 are angled at slightly more that ninety degrees from the bottom wall 20. The upper portion 14 has a top wall 24 and four upper side walls 26. One of the four upper side walls 26 having an opening or cutout 28. The upper portion 14 has a plurality of handles 29. An internal divider 16 has a floor grate 30 that runs the length of the lower portion 12 and is adjacent to the opening 28. The internal divider 16 has an internal wall 32 that is perpendicular to the floor grate 30 and does not extend the complete length of the lower portion 12 or the upper portion 14. The wall 32 abuts the upper portion 14 to create a passageway. Where the wall 32 ends it creates a second opening from the floor grate 30 passageway into the lower portion 12. The storage shelf 18 has a plurality of openings 34 that snap fit onto a plurality of tabs 36 on the lower portion 12.

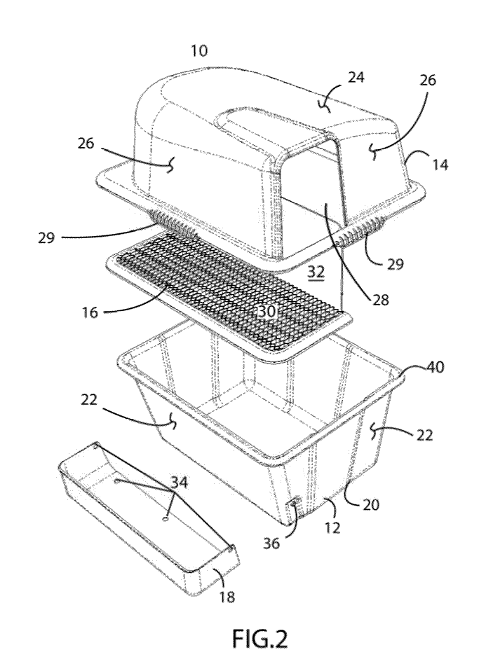

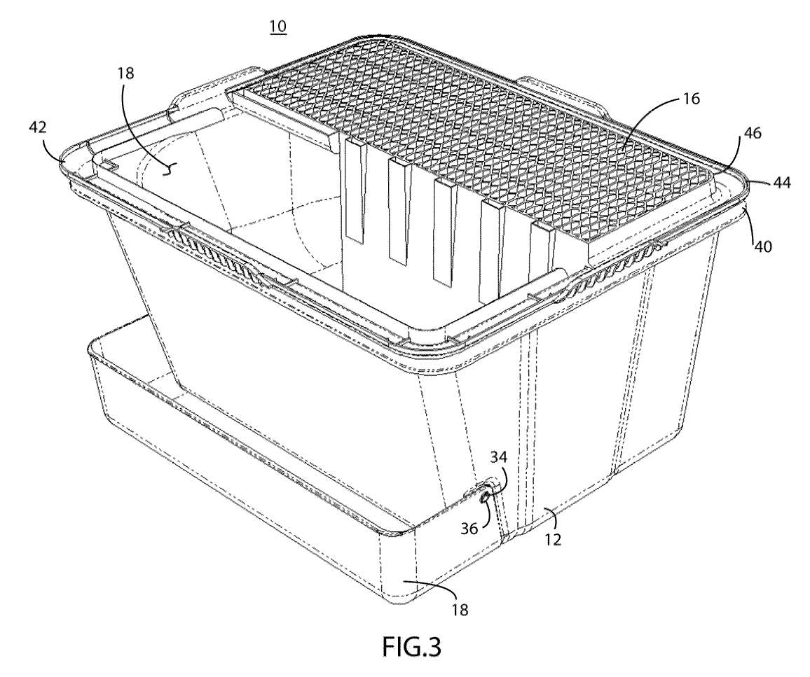

FIG. 2 is an exploded view of the pet litter box 10 in accordance with one embodiment of the invention. This view shows the lower portion 12 is a somewhat rectangular box with obtuse walls 22. The walls 22 terminate in a lip 40 along the periphery of the walls 22. The upper portion 14 has a grove 42 (see FIG. 3) along part of a periphery and half grove or lip 44 along the rest of the periphery that mates with the lip 40 of the lower portion 12. The divider portion 16 includes a step 46 along its periphery. The step 46 and the half groove 44 form a full groove that mates with the lip 40 of the lower portion.

FIG. 3 is a top left perspective view of the pet litter box 10 nested for shipping in accordance with one embodiment of the invention. This figure shows how the litter box 10 nests for shipping. The upper portion 14 when turned over nests inside the lower portion 12. The divider portion 16 nests inside the upper portion 14.

In operation litter is placed in the lower portion 12, with or without a plastic bag. The divider portion 16 is placed on top of the lip 40 of the lower portion 40. Then the upper portion 14 is placed on the lip 40 of lower portion 12. When a cat or other pet needs to use the litter box, they jump from the floor through the opening 28 onto the grate floor 30. Then they walk along the grate floor 30 until they reach the end of the divider wall 32 and jump through the opening formed by the upper portion 14, the grate floor 30, and the divider wall 32 into the lower portion 12 containing the litter. The cat does their business and then jumps from the 12 portion onto the grate floor 30. Note that it is impossible for the cat to jump from the lower portion 12 through opening 28 onto the floor, since the cat is forced to turn a corner. As result, the cat walks along the grate or screen floor 30 causing litter on the cats paws to come loose and fall through the crate down into the lower portion 12.

The overlap between the lip 40 of the lower portion 12 and the groove 42 and 44 & 46 formed by the upper portion 14 and the divider wall 16, prevents any urine leakage out of the litter box 10.

Thus there has been described that stops dog snacking, reduces tracking, stops urine leaks and can be shipped inexpensively.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A pet litter box, comprising:
a lower portion having a bottom wall and four lower portion side walls that are at slightly more than ninety degrees from the bottom wall;
an upper portion having a top wall and four upper portion side walls, a cutout portion in one of the four upper portion side walls, the four upper side walls terminating in a groove that mates with a lip formed by the four lower portion side walls; and
an internal divider has a floor grate that extends along a length of the lower portion, has a wall at approximately ninety degrees to the floor grate, the wall does not extend the length of the lower portion, a divider groove that mates with the lip of the lower portion, whereby a pet entering or exiting the pet litter box is required to make a turn on the grate.

2. The pet litter box of claim 1, further including a storage shelf that snap fits onto an outside of the lower portion.

3. The pet litter box of claim 1, upper portion includes a pair of handles.

4. The pet litter box of claim 1, wherein the upper portion nests with the lower portion when turned upside down.

5. The pet litter box of claim 1, wherein the internal divider nests inside the lower portion.

6. A litter box, comprising:
a lower portion for containing a litter;
an upper portion fitting on top of the lower portion and having a pet opening; and
a divider portion having a grate floor and a wall divider perpendicular to the grate floor, the divider portion fitting on top of the lower portion.

7. The liter box of claim 6 further including a storage shelf that snap fits onto the lower portion.

8. The litter box of claim 6, wherein the upper portion nests inside the lower portion for shipping.

9. The litter box of claim 6, wherein the upper portion has a groove along a part of a periphery.

10. The litter box of claim 9, wherein the divider portion includes a step along a periphery of the grate floor.

11. The litter box of claim 6, wherein the lower portion has a lip along its periphery that mates with the groove of the lower portion.

12. The litter box of claim 6, wherein the lower portion is a somewhat rectangular box with obtuse walls.

13. The litter box of claim 12, wherein the upper portion includes a plurality of handles.

14. The litter box of claim 13, wherein the upper portion includes a roof supported by a plurality of side walls.

15. A litter box comprising:
a housing having a pet opening;
a screen floor adjacent to the pet opening;
a wall along a portion of the screen floor, whereby a pet entering or exiting the litter box has to make a turn along the screen floor.
